(19) United States
(12) Patent Application Publication
(10) Pub. No.: US 2026/0075039 A1
(43) Pub. Date: Mar. 12, 2026

(54) PROGRAMMING RELAY DEVICE AND METHODS FOR MACHINE CONTROL SYSTEMS

(71) Applicant: Connections Design, LLC, Springfield, MO (US)

(72) Inventor: Kevin Edward WYAS, Springfield, MO (US)

(21) Appl. No.: 19/310,440

(22) Filed: Aug. 26, 2025

Related U.S. Application Data
(60) Provisional application No. 63/693,449, filed on Sep. 11, 2024.

(51) Int. Cl. H04L 9/40

(52) U.S. Cl. CPC H04L 63/0281

(57) ABSTRACT

Embodiments for programming a control system of a machine, such as a vehicle, are provided. Some machines may include security firewalls such as Security Gateway Modules (SGMs) that restrict access to the machine control systems. By utilizing a programming tool and a transition gateway module, embodiments of the present invention may allow unrestricted access to the machine control systems. For example, the programming tool may generate an original message containing an SGM-restricted parameter and then modify it with an SGM-authorized parameter in the header while embedding the restricted parameter in the payload of the message. This modified message bypasses the SGM and reaches the transition gateway module, which restores the original parameter before broadcasting to the electronic control units (ECUs), allowing for more accessible and cost-effective maintenance by bypassing the need for manufacturer-specific tools and permissions.

### BACKGROUND

A multitude of devices and techniques are utilized in the realm of machinery maintenance and diagnostics to ascertain machine health and facilitate adjustments to machine settings. Among these are diagnostic tools that connect directly to a machine's diagnostic port, such as an OBD (On-Board Diagnostics) port. Through this connection, these devices can request and gather diagnostic data from the machine's intricate control system, which often includes numerous electronic control units (ECUs). These ECUs may be linked via a sophisticated network of multiplex electrical wiring, necessitating standardized communication protocols to ensure efficient message transmission throughout the system. These protocols prescribe precise guidelines for interfacing with machine control systems to retrieve, update, or modify settings. However, while some devices are adept at proper interfacing with the machine control systems, they are frequently restricted to operations specific to the manufacturer and may lack the capability to perform a comprehensive range of desired functions. For example, limitations imposed by Security Gateway Modules (SGMs) may function like firewalls, restricting access to certain diagnostic and programming operations. Conventional diagnostic tools with programming functionality can work in conjunction with security bypass modules that effectively disable the SGM to allow such messages to go through the SGM without modification.

### SUMMARY

Embodiments of the present invention relate to systems and methods for updating a control system of a machine that overcomes the limitations of SGMs. To overcome these limitations, a combination of a programming tool and a transition gateway module may be employed. The programing tool may interface with the machine’s diagnostic port, initiating communication and diagnostic operations. Positioned downstream of the SGM, the transition gateway module facilitates the seamless flow of modified messages to the machine’s ECUs.

The process may begin with the programming tool generating an original message (e.g., an International Organization for Standardization – Transport Protocol (ISOTP) message) that contains an SGM-restricted parameter, such as a write command. The tool may then modify this message by changing the restricted parameter in the header to an SGM-authorized parameter, such as a read command, and embeds the original, restricted parameter within the message payload. This modified message, now featuring an SGM-authorized parameter in the header, passes through the SGM without being blocked, as the SGM only recognizes the authorized parameter and allows the message to proceed.

Once the modified message reaches the transition gateway module, the module may revert the SGM-authorized parameter back to the original SGM-restricted parameter, helping ensure that the message retains its intended command and functionality. The transition gateway module may then broadcast the original message to the ECUs, where the targeted ECU receives and processes the original command as intended, allowing for diagnostics and programming of ECUs that were previously restricted by the SGM.

Such an approach may significantly enhance the capability and flexibility of machine diagnostics and maintenance, providing operators with the tools to perform unrestricted and efficient machine management. Operators may no longer be limited by manufacturer-specific restrictions imposed by SGMs or vehicle manufacturer-specific SGM bypass devices, enabling a broader range of diagnostics and modifications. This may result in more comprehensive maintenance and diagnostic modifications, reduced downtime, and more accessible and cost-effective maintenance by bypassing the need for manufacturer-specific tools and permissions.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is an exemplary operating environment of a programming tool, a transition gateway module, and a communications management system described in accordance with some embodiments of the present invention;

FIG. 2 is a flow diagram showing an exemplary process flow for programming a machine or machine control system in accordance with some embodiments of the present invention;

FIG. 3 is a perspective view of an exemplary circuit board of a transition gateway module in accordance with some embodiments of the present invention;

FIG. 4 is a flow diagram showing an exemplary method for wirelessly programming a control system of a machine in accordance with some embodiments of the present invention; and

FIG. 5 is a block diagram of an exemplary computing environment suitable for use in implementing some embodiments of the present invention.

### DETAILED DESCRIPTION

A variety of machines, such as automobiles, generally include a complex network of electronics that each serve a specific purpose to overall functionalities and features. Certain diagnostics tools can physically plug into a port of a machine (e.g., an OBD port) and request and/or collect diagnostics information from ECUs of a machine’s control system.

As used herein, an “ECU,” short for electronic control unit, is a specialized system that controls specific functions of a machine, such as engine management, transmission control, braking systems, etc. ECUs can communicate over an interconnecting communications bus. A controller area network bus (CAN bus) is one non-limiting example of such a communications bus. Generally speaking, ECUs can broadcast messages throughout the control system via the communications bus without a host computer. Messages broadcast over the communications bus generally must comply with standardized protocols, designed for an array of multiplex electrical wiring that interconnects the ECUs.

As used herein, an “Arbitration ID” (ARB ID) is an identifier that may be used in a communications bus to manage and prioritize messages. For example, ARB IDs may help in identifying the source of a message and/or the intended destination of the message, facilitating efficient communication and message filtering by ECUs and other devices within the communications bus. A “programming ARB ID” may be a type of ARB ID used for messages related to programming or configuring devices and may include software updates, parameter changes, and/or other configuration commands. A “relay ARB ID” may refer to an identifier used for messages that are forwarded through the communications bus, which may help ensure that data reaches the intended destination. Although these ARB IDs are typically used as identifiers for vehicle components, the present invention also contemplates leveraging these ARB IDs as identifiers to aid a programming tool of the present invention in executing tasks to bypass the SGM, as will be discussed further herein.

As used herein, an “SGM” is a component within a machine designed to manage and protect the communication between various ECUs and diagnostic tools. Acting somewhat like a firewall, the SGM controls access to the machine’s internal network, helping ensure that only authorized messages and commands can pass through. An SGM helps prevent unauthorized access by filtering and validating incoming and outgoing communications.

As used herein, a “programming tool” is a type of diagnostic tool used to connect to a machine for the purpose of monitoring, diagnosing, and/or troubleshooting various systems and components of the machine. The programming tool may interface with the machine’s control system via standardized ports to retrieve diagnostic information, read error codes, and perform adjustments or updates. One example of such a programming tool is the ECRI Calibrator, by Connections Design, LLC, which is the subject of US Patent 11,296,906, assigned to the same entity as this application, the entire contents being herein incorporated by reference. The programming tool of the present invention functions as a sophisticated diagnostic tool capable of executing tasks to bypass the SGM in order to program various systems and components of the machine.

As used herein, a “transition gateway module” is a component that facilitates the transfer of data between various systems and components of a machine’s control system. The transition gateway module may operate in conjunction with a programming tool to enable diagnostics and programming tasks that the programming tool alone cannot accomplish without a conventional security bypass module. Positioned anywhere within the machine’s control system, and preferably between an SGM and one or more ECUs, the transition gateway module may intercept and restore modified messages originated or generated at the programming tool after they pass through the SGM. The transition gateway module helps ensure that commands and data, first modified by the programming tool to bypass the SGM, can be restored to their original state to reach the intended ECUs and execute various operations on the machine’s systems.

The example aspects and embodiments described in the present disclosure are provided within the context of a vehicle and a communications bus therein. However, it should be understood that the principles and techniques discussed herein are not limited to vehicles alone. The concepts and methodologies can be equally applied to other types of communications networks in other machine systems. These alternative machine systems are capable of supporting the functionalities and applications described, and their use falls within the scope of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Accordingly, a first aspect of the present disclosure is directed to a computerized system for bypassing a security gateway module (SGM) on a communications bus of a machine. For example, the system includes a programming tool and a transition gateway module. The programming tool is configured to obtain an original message for communication to an electronic control unit (ECU) of the machine, the original message being identified by at least one SGM-restricted parameter and comprising an original payload. The programming tool is further configured to modify the original message such that it is identified by a unique set of SGM-authorized parameters instead of the at least one SGM-restricted parameter and to communicate the modified message to the communications bus, wherein the SGM is configured to authorize pass-through of the modified message based on the unique set of SGM-authorized parameters. The transition gateway module is configured to receive the modified message after it bypasses the SGM and, based on determining that the modified message is identified by the unique set of SGM-authorized parameters, restore the original message based on the original payload and the at least one SGM-restricted parameter stored in a memory of the transition gateway module. The transition gateway module is further configured to communicate the restored original message to the ECU via the communications bus.

A second aspect of the present disclosure is directed to a non-transitory computer-storage media storing computer-useable instructions that, when used by one or more computing devices, cause the one or more computing devices to perform operations for bypassing a security gateway module (SGM) on a communications bus of a machine. For example, the computer-useable instructions comprise obtaining an original message for communication to an electronic control unit (ECU) of the machine, the original message being identified by at least one SGM-restricted parameter and comprising an original payload. The computer-useable instructions further comprise modifying the original message such that it is identified by a unique set of SGM-authorized parameters instead of the at least one SGM-restricted parameter. The computer-useable instructions further comprise communicating the modified message to the communications bus, wherein the SGM is configured to authorize pass-through of the modified message based on the unique set of SGM-authorized parameters. The computer-useable instructions further comprise receiving the modified message after it bypasses the SGM. The computer-useable instructions further comprise, based on determining that the modified message is identified by the unique set of SGM-authorized parameters, restoring the original message based on the original payload and the at least one SGM-restricted parameter stored in a memory of the transition gateway module. The computer-useable instructions further comprise communicating the restored original message to the ECU via the communications bus.

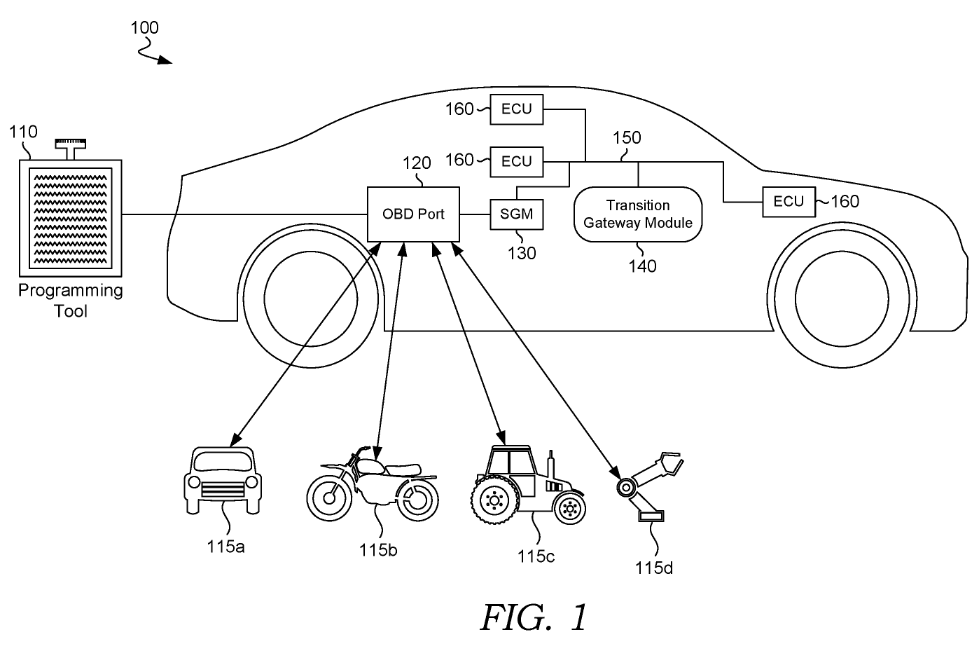

Turning now to FIG. 1, a schematic depiction is provided illustrating an exemplary system 100 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 100 in FIG. 1 can include a programming tool 110, an OBD port 120, an SGM 130, a transition gateway module 140, a communications bus 150, and/or one or more ECUs 160. In various embodiments, the programming tool 110 can include a connector that physically plugs into a port (e.g., OBD port 120) of a machine, such as machines 115A, 115B, 115C, 115D, by way of non-limiting example. In accordance with various embodiments, a machine such as machines 115A-D can include a vehicle (e.g., car, motorcycle), an airplane, a tractor, a truck, a piece of construction equipment, heavy machinery, a robot, a hydraulic machine, or any other type of vehicle or machine without limitation. In some embodiments, the OBD port of the machine can include a diagnostics port (e.g., an OBD-II port) coupled to the communications bus 150 (e.g., CAN bus) of a control system associated with the machine. The control system may comprise one or more ECUs 160 that may respectively include a memory, a microprocessor, or other components that facilitate the control of a particular module or feature of the machine.

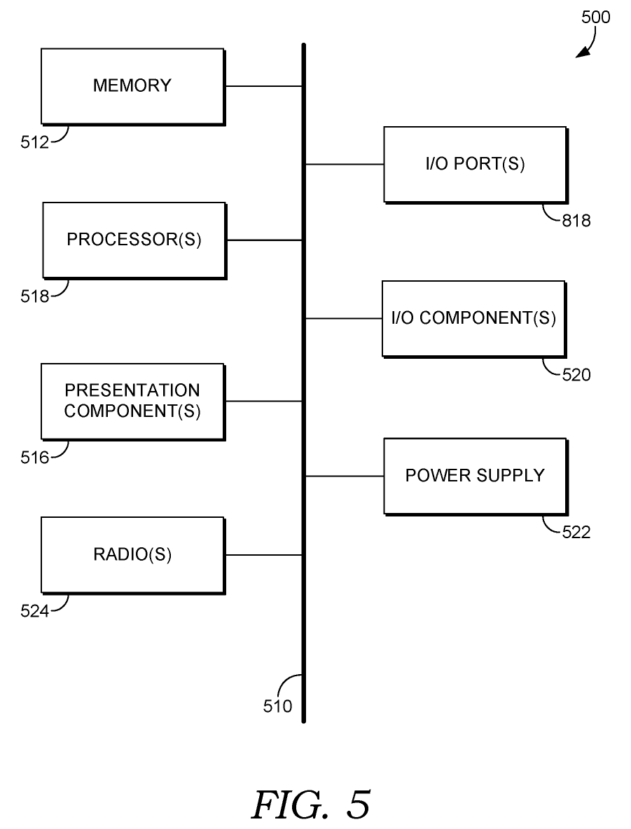

In some embodiments, each ECU 160 can comprise a computing device, such as computing device 500 of FIG. 5, whereby the ECUs are interconnected to one another via the communications bus. In some aspects, each ECU may store in an associated memory (i.e., a memory module) a respective set of parameters, settings, or the like. In some further aspects, each ECU may receive messages via the network bus, or generate messages to broadcast via the communications bus based on received messages, among other things. Similarly, in some embodiments, the programming tool 110 and the transition gateway module 140 may comprise a computing device such as computing device 500 of FIG. 5, including an associated memory and an ability to receive, generate, and/or broadcast messages via the communications bus.

The communications bus 150 may be a central pathway that facilitates data exchange between the SGM 130, the transition gateway module 140, and one or more ECUs 160 within a machine (e.g., vehicles 115a-d). The communications bus 150 helps ensure that connected components can communicate effectively. The communications bus 150 may operate on a standardized protocol (e.g., CAN bus), supporting robust and reliable communication. The communications bus 150 may allow for the continuous exchange of data packets between the SGM 130, the transition gateway module 140, and the one or more ECUs 160. The communications bus 150 may be accessible to external diagnostic tools (e.g., programming tool 110) through a port (e.g., OBD port 120). This may enable a technician to monitor, diagnose, and reprogram the ECUs 160 by sending and receiving data for maintenance and troubleshooting. Messages transmitted over the communications bus 150 may include various types of data, such as sensor readings, control commands, diagnostic information, and/or configuration parameters. Each message may be identified by an ARB ID that helps determine its priority and proper routing within the machine.

The programming tool 110 is designed to help facilitate diagnostic and maintenance operations by obtaining and processing messages for communication with the one or more ECUs 160. For example, the programming tool 110 may generate or obtain an original message intended for an ECU 160. The original message may be characterized by the presence of at least one SGM-restricted parameter, which could include a write parameter, a code clear parameter, a routine start parameter, or a target ARB ID. These parameters are typically restricted by the SGM 130 to control and limit access to certain functions of the machine.

The original message may also comprise an original payload, which may include the specific programming information or commands intended for the ECU 160. The original payload may contain data necessary for updating the software of the ECU 160, clearing diagnostic trouble codes, initiating specific routine, or executing other functions. Due to the presence of the SGM-restricted parameter, however, the original message may not directly pass through the SGM 130, which may be configured to block the original message based on the at least one SGM-restricted parameter. Instead, the programming tool 110 may modify the message to help ensure it can bypass the SGM’s 130 restrictions and successfully reach the ECU 160.

The programming tool 110 may modify the original message by replacing the at least one SGM-restricted parameter with a unique set of SGM-authorized parameters. For example, the programming tool 110 may substitute the at least one SGM-restricted parameter with a read data parameter and a relay ARB ID, which are recognized and permitted by the SGM 130. To retain the at least one SGM-restricted parameter for later restoration, the programming tool 110 may incorporate the at least one SGM-restricted parameter into the original payload of the message. When the programming tool 110 communicates the modified message to the communications bus 150, the SGM 130, which is coupled to the communications bus 150 between the OBD port 120 and the transition gateway module 140, is configured to authorize pass-through of the modified message based on the unique set of SGM-authorized parameters without obstruction.

After the modified message successfully bypasses the SGM 130, it is received by the transition gateway module 130. The transition gateway module 130 may be configured to listen for particular ARB IDs, such as a relay ARB ID that is unused by the machine and not restricted by the SGM 130. Such ARB IDs may serve as a signal to the transition gateway module 140 that the incoming message has been modified to circumvent the SGM’s 130 restrictions. Upon receiving the modified message, the transition gateway module 140 may determine that it is identified by the unique set of SGM-authorized parameters (e.g., the read data parameter and the relay ARB ID). Based on this identification, the transition gateway module 140 may then proceed to restore the original message by reassembling it based on the original payload and the at least one SGM-restricted parameter.

The process of restoring the original payload may involve extracting the at least one SGM-restricted parameter from the payload where it was embedded by the programming tool 110. This parameter, which could include critical commands like a write parameter, code clear parameter, or routine start parameter, is then reinstated in its appropriate place within the message. In some cases, the at least one SGM-restricted parameter may be predefined and stored in the memory of the transition gateway module 140 so that it is already available for the restoration process. Once the original message is restored, with its original payload and SGM-restricted parameters in place, the transition gateway module 140 communicates this restored original message to the ECU 160 via the communications bus 150. Since the original message may include programming information for the ECU 160, communication of the original message to the ECU 160 may cause one or more parameters of the ECU 160 to be updated. Accordingly, the ECU 160 may receive the intended commands and/or programming information without any interference from the SGM’s 130 security measures.

In some aspects, in order to restore the original message, the transition gateway module 140 may segment the at least one SGM-restricted parameter and the original payload from the modified payload before reconstructing the original message. When the modified message is received, the transition gateway module 140 identifies the unique set of SGM-authorized parameters. The transition gateway module 140 may then segment the SGM-restricted parameter from the modified payload. This parameter may be extracted and stored in the memory of the transition gateway module 140, which may help ensure it is not lost and can be accurately reinserted into the original message during the restoration process. For example, if the modified message included a read command to bypass the SGM 130, the transition gateway module 140 would segment this read command and replace it with the original write command stored in its memory. To do this, after segmenting and storing the at least one SGM-restricted parameter, the transition gateway module 140 may combine the at least one SGM-restricted parameter with the original payload, thereby restoring the original message as it was intended before modification. This restored message, now containing the intended SGM-restricted parameter and original payload, is then communicated to the ECU 160 via the communications bus 150. By performing these segmentation and restoration steps, the transition gateway module 140 may help ensure that the ECU 160 receives the accurate commands and programming information for effective and unrestricted diagnostic and maintenance operations, despite the security restrictions initially imposed by the SGM 130.

In some aspects, the transition gateway module 140 may be configured in advance by a transition gateway message that precedes the modified message and may replace or be additive to the segmentation restoration discussed previously. This process may involve another unique set of SGM-authorized parameters, distinct from the ones used for the modified message. For example, this other unique set of SGM-authorized parameters may include a read parameter (or a different data parameter) and a programming ARB ID, which the transition gateway module 140 is specifically configured to listen to for programming purposes. The process may begin with the programming tool identifying the original message by its at least one SGM-restricted parameter, such as a write command. In response, the programming tool may generate a transition gateway message, which may be identified by another unique set of SGM-authorized parameters and includes the SGM-restricted parameter within its payload (e.g., a transition gateway payload).

Since the transition gateway message is marked with another unique set of SGM-authorized parameters, it can pass through the SGM 130 without being blocked. Once through the SGM 130, this transition gateway message may be received by the transition gateway module 140, which may be configured to listen for this programming ARB ID associated with these particular SGM-authorized parameters. Upon identifying the transition gateway message by this other unique set of SGM-authorized parameters, the transition gateway module 140 extracts the at least one SGM-restricted parameter from the payload and stores it in its memory. This may help ensure that the transition gateway module 140 is pre-configured with the at least one SGM-restricted parameter before the modified message arrives. When the modified message subsequently comes through, the transition gateway module 140 may simply replace the unique set of SGM-authorized parameters in the header of the modified message with the stored SGM-restricted parameters before forwarding the restored original message to the ECU 160.

Such configuration messages (e.g., transition gateway messages) for the transition gateway module 140 can also be used to instruct the transition gateway module 140 on which ARB ID (e.g., relay ARB ID) to monitor for identifying modified messages that need restoration. For example, if it is known that relay ARB ID 732 is not currently being used by the machine and is an SGM-authorized parameter, this ID can be utilized to help the transition gateway module 140 identify the modified message it should process. In this case, a transition gateway message can be generated to store the relay ARB ID 732 in the transition gateway module’s 140 memory. This configuration message, marked with another unique set of SGM-authorized parameters, would pass through the SGM 130 and be received by the transition gateway module 140. Upon receipt, the transition gateway module 140 extracts the relay ARB ID from the transition gateway message payload and stores it in its memory. This allows the transition gateway module 140 to recognize and listen for incoming modified messages identified by relay ARB ID 732, helping to ensure the transition gateway module 140 can restore the modified messages to their original form before forwarding them to the ECU 160.

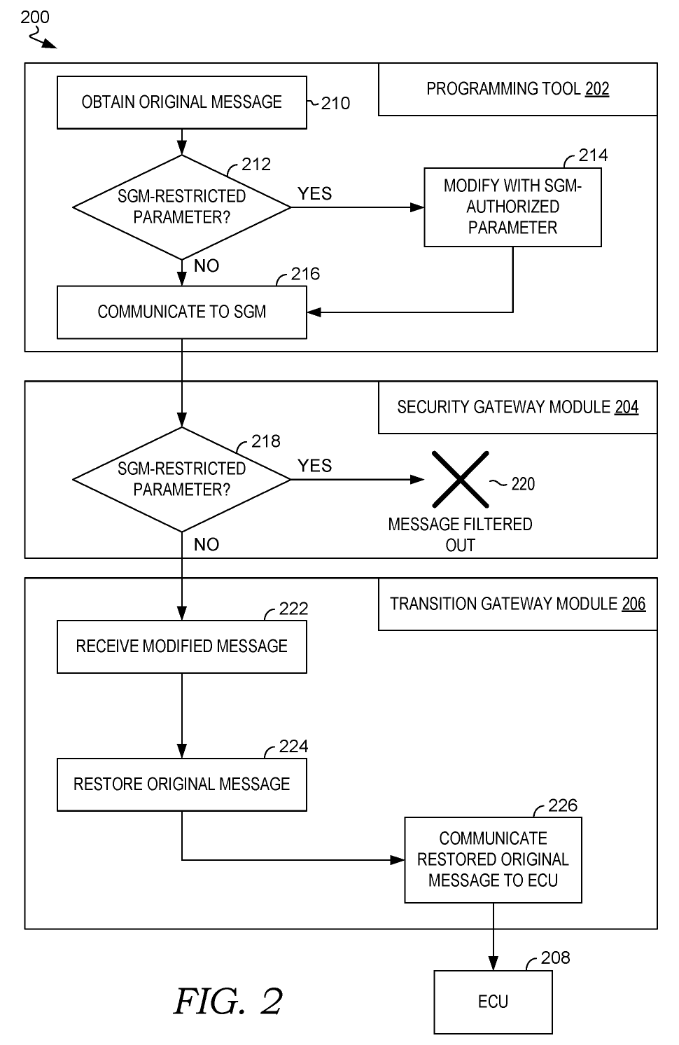

Looking now to FIG. 2, a flow diagram 200 is provided showing an exemplary process flow for programming a machine, in accordance with some embodiments of the present invention.

It should be understood that the exemplary process flow described here is not intended to be limiting, and that any one or more separate portions of the process flow can be uniquely separated from other portions in accordance with various embodiments described herein. The depicted process flow is provided merely as an exemplary process flow for wirelessly programming one or more portions of a machine, such as non-limiting examples 115A-F of FIG. 1, or in other words the control system thereof. It is further noted that references to a message, a message portion, flow control message, or a frame described herein corresponds to a piece of electronic data, such as an electronic data object or an electronic dataset.

At step 210, a programming tool 202, which may have the same or similar functionality of the programming tool 110 of FIG. 1, obtains an original message. The original message may be characterized by at least one SGM-restricted parameter, such as a write parameter, code clear parameter, routine start parameter, or a specific target ARB ID. Additionally, the original message may comprise an original payload that includes programming information or commands intended for an ECU 208 of a machine.

At step 212, the programming tool 202 analyzes the original message to determine if it contains at least one SGM-restricted parameter. If the programming tool 202 finds that there are no SGM-restricted parameters in the original message, it will simply communicate the original message directly to the SGM 204, allowing it to pass through without any modifications. However, if the programming tool 202 identifies that the original message does contain at least one SGM-restricted parameter, it will proceed to the next step, which involves modifying the message to ensure it can bypass the SGM’s 204 restrictions.

At step 214, upon determining that the original message contains at least one SGM-restricted parameter, the programming tool 202 proceeds to modify the original message to ensure it can bypass the SGM 204. The programming tool 202 may replace the at least one SGM-restricted parameter in the original message with a unique set of SGM-authorized parameters. For example, the programming tool 202 might substitute a write parameter with a read data parameter and/or change the target ARB ID to a relay ARB ID that is not restricted by the SGM 204. Furthermore, in some aspects, the programming tool 202 may embed the original SGM-restricted parameter into the payload of the modified message so that it can be preserved and restored later. Once the original message has been modified such that it at least can be identified by the unique set of SGM-authorized parameters, it is ready to be communicated to the SGM 204.

Alternatively, at step 214, the programming tool 202 may generate and send a preceding configuration message (e.g., transition gateway message) based on the original message. This configuration message, identified by another unique set of SGM-authorized parameters, includes the SGM-restricted parameter in its payload. The configuration message instructs a transition gateway module 206, which may have the same or similar functionality as the transition gateway module 140 of FIG. 1, to store this parameter in its memory so that when the modified original message discussed above reaches the transition gateway module 206, the transition gateway module 206 can recognize it and restore the original message using the pre-stored at least one SGM-restricted parameter.

At step 216, the modified message (or the transition gateway message) is communicated to the SGM 204. At step 218, the SGM 204 determines whether the modified message contains at least one SGM-restricted parameter. The SGM 204 is configured to allow messages identified by authorized parameters to pass through without obstruction. Such a configuration means that, despite the original message containing at least one SGM-restricted parameter, the modified message can bypass the security measures of the SGM 204 because it is now identified by parameters such as a read data parameter and/or a relay ARB ID that are authorized by the SGM 204.

In contrast, at step 220, if the modified message were to contain at least one SGM-restricted parameter and had not been modified accordingly, the SGM 204 would filter the message out. For example, the SGM 204 may actively scan incoming messages for restricted parameters, such as a write command, code clear parameter, or specific target ARB IDs. If any of these restricted parameters are detected, the SGM 204 blocks the message from pass through to the ECU 208.

At step 222, the transition gateway module 206 receives the modified message after it has successfully passed through the SGM 204. The modified message, which may contain the unique set of SGM-authorized parameters, has bypassed the SGM’s 204 restrictions and is now ready for processing by the transition gateway module 206.

At step 224, the transition gateway module 206 may identify the modified message by identifying the unique set of SGM-authorized parameters. The transition gateway module 206 may then segment the at least one SGM-restricted parameter and the original payload from the modified message’s payload. The transition gateway module 206 may then use the segmented at least one SGM-restricted parameter, which may be stored in its memory, to replace the SGM-authorized parameters in the modified message, thereby restoring the original message. For example, a write command that was replaced with a read command to bypass the SGM 204 may be reinserted into the message, along with the original payload, to recreate the original message.

In some aspects at step 224, the transition gateway module 206 may have been pre-configured to restore the original message through a preceding transition gateway message as discussed above. In such aspects, the programming tool 202 sends the transition gateway message, which is identified by another unique set of SGM-authorized parameters different from the unique set of SGM-authorized parameters. This transition gateway message includes the SGM-restricted parameter in its payload and instructs the transition gateway module 206 to store it in its memory. When subsequent modified message arrives at the transition gateway module 206, the transition gateway module 206 uses the pre-stored at least one SGM-restricted parameter to restore the original message.

At step 226, the transition gateway module 206 communicates the restored original message to the ECU 208 via a communications bus (e.g., communications bus 150). After successfully restoring the original message to its original form, including the original payload and the at least one SGM-restricted parameter, the transition gateway module 206 helps ensure that the ECU 208 receives the message in the correct format with the data intact. Upon receiving the restored original message, the ECU 208 processes the commands and/or programming information as intended, executing the functions or updates. This step may complete the process of helping to ensure that the diagnostic and maintenance operations can be carried out effectively, without being hindered by the restrictions imposed by the SGM 204.

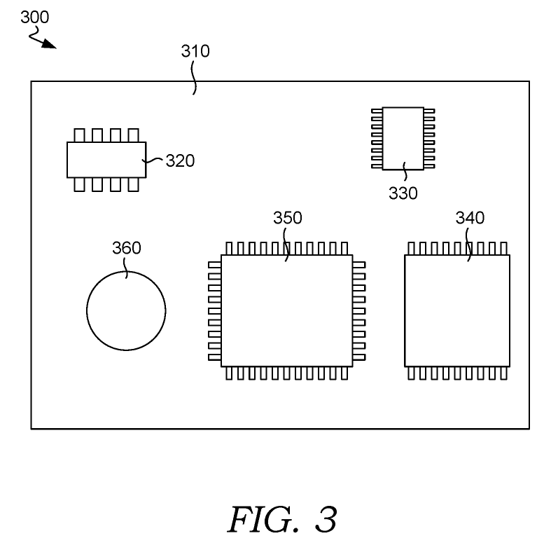

Looking now to FIG. 3, a perspective view is provided depicting an exemplary circuit board 310 of a transition gateway module 300, such as transition gateway module 140 of FIG. 1 and/or transition gateway module 206 of FIG. 2, in accordance with some embodiments of the present invention. The depicted circuit board 310 is not intended to be limiting, and is only presented as an exemplary embodiment of a build configuration that may be employed within the purview of the present disclosure. The circuit board 310 may include any one or more of a power regulator 320, a “plug” 330, a CAN bus transceiver 340, a microcontroller unit (MCU) 350, and a crystal oscillator 360.

The power regulator 320 helps ensure that the various components of the module receive the appropriate voltage levels needed for their operation. For instance, if the circuit board requires 5V while the CAN bus supplies 12V, the power regulator will step down the 12V from the CAN bus to the required 5V. By doing so, the power regulator helps provide a steady power supply to the circuit board while receiving power from the CAN bus, which can protect against potential damage due to overvoltage.

The plug 330 serves as an interface connecting the transition gateway module 300 to a communications bus situated between a SGM and an ECU. The plug 330 may be designed as a multi-pin connector with a pig-tail connector to allow for flexible and convenient routing within a system. The plug 330 may support the protocols and data rates for a specific type of communications bus, such as a CAN bus. Such a configuration of the plug 330 may help the transition gateway module 300 to effectively intercept and modify messages, helping ensure seamless data flow between a programming tool, such as programming tool 110 of FIG. 2 and/or programming tool 202 of FIG. 2, while also providing the necessary power connections for the transition gateway module’s 300 operations.

The CAN bus transceiver 340 may interface with the CAN bus system. The transceiver 340 is responsible for receiving signals from the plug 330 that connect the transition gateway module 300 to the CAN bus. The transceiver 340 may receive differential signals from the CAN bus through the plug 330 and convert them into a format suitable for the transition gateway module’s 300 internal circuitry and also transmitting signals from the transition gateway module 300 back to the CAN bus. The transceiver 340 may also handle converting voltage levels down to the appropriate I/O levels that the MCU 350 can handle, which may provide electrical isolation and protection to the MCU 350.

The MCU 350 may perform the processing tasks of the transition gateway module 300 discussed previously in regards to FIGS. 1 and 2 to bypass a SGM and facilitate unrestricted diagnostics and maintenance operations. Once the transceiver 340 has converted the CAN bus signals to the appropriate I/O voltage levels, the MCU 350 processes these signals to execute the processing tasks. The MCU 350 then broadcasts (e.g., communicates the restored original message) to an ECU via the CAN bus where the ECU may receive and process the original command as intended, allowing for diagnostics and adjustments that were previously restricted by the SGM.

The crystal oscillator 360 may utilize the mechanical resonance of a vibrating quartz crystal to generate a consistent and stable electrical signal at a specific frequency. This stable timing signal may help synchronize the operations of the MCU 350 to help ensure accurate data processing and communication. By providing a reliable clock source, the crystal oscillator 360 helps enable the MCU 350 to execute its tasks with precise timing, which contributes to the effective bypassing of a SGM and facilitating comprehensive diagnostic and maintenance activities.

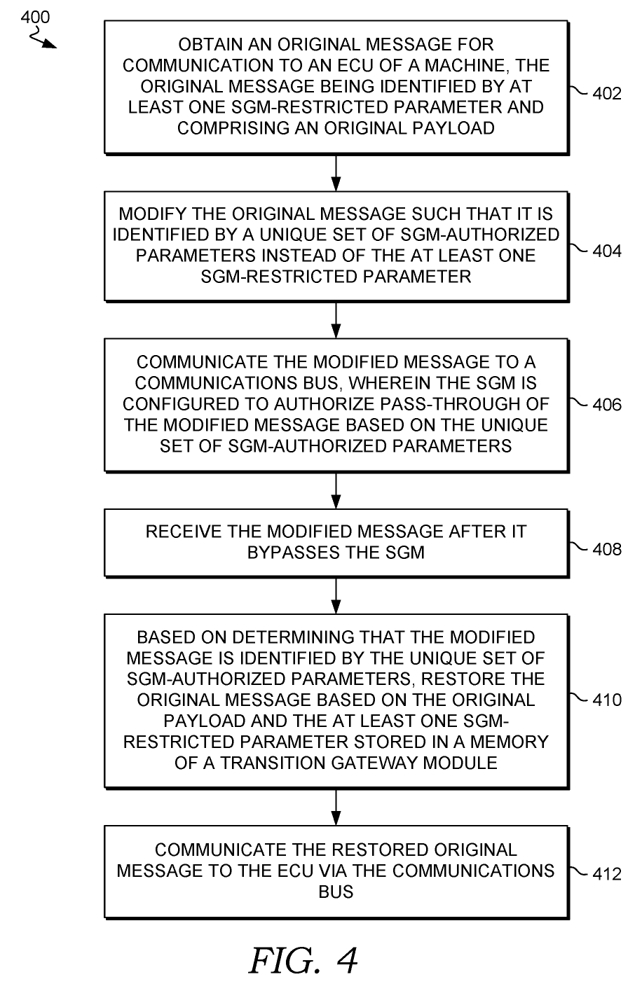

Turning now to FIG. 4, a flow diagram is provided that illustrates a method for bypassing a SGM on a communications bus of a machine, in accordance with some embodiments described herein. A programming tool, such as programming tool 110 of FIG. 1 and/or programming tool 202 of FIG. 2, may be physically coupled to a diagnostic port (e.g., an OBD-II port) of the machine. A transition gateway module, such as transition gateway module 140 of FIG. 1 and/or transition gateway module 206 of FIG. 2, may be physically coupled to a communications bus of the machine between the SGM and an ECU. In combination, the programming tool and the transition gateway module may perform the method of FIG. 4.

At step 402, the programming tool obtains an original message for communication to an ECU of a machine. The original message is identified by at least one SGM-restricted parameter and comprises an original payload. At step 404, the programming tool modifies the original message such that it is identified by a unique set of SGM-authorized parameters instead of the at least one SGM-restricted parameter. At step 406, the programming tool communicates the modified message to a communications bus, the SGM being configured to authorize pass-through of the modified message based on the unique set of SGM-authorized parameters.

At step 408, the transition gateway module receives the modified message after it bypasses the SGM. At step 410, the transition gateway module, based on determining that the modified message is identified by the unique set of SGM-authorized parameters, restores the original message based on the original payload and the at least one SGM-restricted parameter stored in a memory of the transition gateway module. At step 412, the transition gateway module communicates the restored original message to the ECU via the communications bus.

Having described embodiments of the present invention, an exemplary operating environment in which embodiments of the present invention may be implemented is described below in order to provide a general context for various aspects of the present invention. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output (I/O) ports 518, input/output components 520, and an illustrative power supply 822. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be equipped with depth cameras, such as stereoscopic camera systems, infrared camera systems, RGB camera systems, touchscreen technology, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, embodiments of the present invention provide for, among other things, programming a control system of a machine. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A computerized system for bypassing a security gateway module (SGM) on a communications bus of a machine, the computerized system comprising:
a programming tool to:
obtain an original message for communication to an electronic control unit (ECU) of the machine, the original message being identified by at least one SGM-restricted parameter and comprising an original payload,
modify the original message such that it is identified by a unique set of SGM-authorized parameters instead of the at least one SGM-restricted parameter;
communicate the modified message to the communications bus, wherein the SGM is configured to authorize pass-through of the modified message based on the unique set of SGM-authorized parameters; and
a transition gateway module to:
receive the modified message after it bypasses the SGM,
based on determining that the modified message is identified by the unique set of SGM-authorized parameters, restore the original message based on the original payload and the at least one SGM-restricted parameter stored in a memory of the transition gateway module, and
communicate the restored original message to the ECU via the communications bus.

2. The system of claim 1, wherein the at least one SGM-restricted parameter is predefined and stored in the memory of the transition gateway module.

3. The system of claim 1, further comprising:
the programming tool to:
modify the original message such that the at least one SGM-restricted parameter is added to the original payload; and
the transition gateway module to:
based on determining that the modified message is identified by the unique set of SGM-authorized parameters, segment the at least one SGM-restricted parameter and the original payload from the modified payload prior to restoring the original message, the at least one SGM-restricted parameter segmented from the modified payload being stored in the memory.

4. The system of claim 1, further comprising:
the programming tool to:
based on determining that the original message is identified by the at least one SGM-restricted parameter, generate a transition gateway message identified by another unique set of SGM-authorized parameters and comprising a transition gateway payload that includes the at least one SGM-restricted parameter,
communicate the transition gateway message to the communications bus, wherein the SGM is configured to authorize pass-through of the transition gateway message based on the other unique set of SGM-authorized parameters; and
the transition gateway module to:
receive the transition gateway message after it bypasses the SGM,
based on determining that the transition gateway message is identified by the other unique set of SGM-authorized parameters, extract the at least one SGM-restricted parameter from the transition gateway payload for storage in the memory.

5. The computerized system of claim 4, wherein the other unique set of SGM-authorized parameters includes a read data parameter and a programming ARB ID.

6. The computerized system of claim 4, wherein the other unique set of SGM-authorized parameters includes a different data parameter and a programming ARB ID.

7. The computerized system of claim 4, wherein the unique set of SGM-authorized parameters includes a read data parameter and a relay ARB ID.

8. The computerized system of claim 7, wherein the transition gateway payload further includes the relay ARB ID, the relay ARB ID being extracted from the transition gateway payload for storage in the memory, wherein the original message is restored based further on the stored relay ARB ID.

9. The computerized system of claim 1, wherein an SGM-restricted parameter is a write data parameter, a code clear parameter, a routine start parameter, or a target arbitration identifier (ARB ID).

10. The computerized system of claim 1, wherein the original payload includes programming information for the ECU.

11. The computerized system of claim 1, wherein the communication of the original message causes one or more parameters of the ECU to be updated.

12. The computerized system of claim 1, wherein the programming tool is configured to communicate messages to the communications bus via a diagnostic port of the machine.

13. The computerized system of claim 12, wherein the SGM is coupled to the communications bus between the diagnostic port and the transition gateway module.

14. The computerized system of claim 1, wherein the SGM is configured to block the original message based on the at least one SGM-restricted parameter.

15. A non-transitory computer storage medium storing computer-useable instructions that, when used by one or more computing devices, cause the one or more computing devices to perform operations comprising:
obtaining an original message for communication to an electronic control unit (ECU) of the machine, the original message being identified by at least one SGM-restricted parameter and comprising an original payload,
modifying the original message such that it is identified by a unique set of SGM-authorized parameters instead of the at least one SGM-restricted parameter;
communicating the modified message to the communications bus, wherein the SGM is configured to authorize pass-through of the modified message based on the unique set of SGM-authorized parameters;
receiving the modified message after it bypasses the SGM;
based on determining that the modified message is identified by the unique set of SGM-authorized parameters, restoring the original message based on the original payload and the at least one SGM-restricted parameter stored in a memory of the transition gateway module; and
communicating the restored original message to the ECU via the communications bus.

16. The computer storage medium of claim 15, the operations further comprising:
modifying the original message such that the at least one SGM-restricted parameter is added to the original payload; and
based on determining that the modified message is identified by the unique set of SGM-authorized parameters, segmenting the at least one SGM-restricted parameter and the original payload from the modified payload prior to restoring the original message, the at least one SGM-restricted parameter segmented from the modified payload being stored in the memory.

17. The computer storage medium of claim 15, further comprising:
based on determining that the original message is identified by the at least one SGM-restricted parameter, generating a transition gateway message identified by another unique set of SGM-authorized parameters and comprising a transition gateway payload that includes the at least one SGM-restricted parameter;
communicating the transition gateway message to the communications bus, wherein the SGM is configured to authorize pass-through of the transition gateway message based on the other unique set of SGM-authorized parameters;
receiving the transition gateway message after it bypasses the SGM;
based on determining that the transition gateway message is identified by the other unique set of SGM-authorized parameters, extracting the at least one SGM-restricted parameter from the transition gateway payload for storage in the memory.

18. The computer storage medium of claim 17, wherein the other unique set of SGM-authorized parameters includes a read data parameter and a programming ARB ID.

19. The computer storage medium of claim 17, wherein the unique set of SGM-authorized parameters includes a read data parameter and a relay ARB ID.

20. The computer storage medium of claim 19, wherein the transition gateway payload further includes the relay ARB ID, the relay ARB ID being extracted from the transition gateway payload for storage in the memory, wherein the original message is restored based further on the stored relay ARB ID.
